(19) United States
(12) Patent Application Publication
(10) Pub. No.: US 2016/0368709 A1
(43) Pub. Date: Dec. 22, 2016

(54) GARBAGE RECEPTACLE ASSEMBLY

(71) Applicants: John Kostopoulos, North Beach, NJ (US); Paul Ceglia, North Beach, FL (US)

(72) Inventors: John Kostopoulos, North Beach, NJ (US); Paul Ceglia, North Beach, FL (US)

(21) Appl. No.: 14/745,039

(22) Filed: Jun. 19, 2015

(51) Int. Cl. B65F 1/14; B65F 1/02

(52) U.S. Cl. CPC B65F 1/1615; B65F 1/02; B65F 1/1473

(57) ABSTRACT

A garbage receptacle assembly includes a housing having a bottom wall and a perimeter wall where the perimeter wall includes a front wall, a rear wall, a first lateral wall and a second lateral wall. The perimeter wall has an upper edge defining an opening extending into the housing. Each of the first and second lateral walls has one of a pair of elongated guides attached thereto. A channel is positioned in the rear wall and has an upper end that is in communication with the elongated guides. A cover mounted on the elongated guide is positionable in a closed position closing the opening or in an open position exposing the opening. The cover is removably positioned in the channel when the cover is in the open position. A pair of wheels is rotatably coupled to the housing at a juncture of the perimeter wall and the bottom wall.

### BACKGROUND OF THE DISCLOSURE

### Field of the Disclosure

The disclosure relates to garbage can devices and more particularly pertains to a new garbage can device for preventing the opening of a cover of a garbage receptacle.

### SUMMARY OF THE DISCLOSURE

An embodiment of the disclosure meets the needs presented above by generally comprising a housing having a bottom wall and a perimeter wall that is attached to and extends upwardly from the bottom wall. The perimeter wall includes a front wall, a rear wall, a first lateral wall and a second lateral wall. The perimeter wall has an upper edge defining an opening extending into the housing. The perimeter wall has a height greater than 3.0 feet. A pair of elongated guides is positioned in the housing adjacent to the upper edge. Each of the first and second lateral walls has one of the elongated guides extending from the front wall to the rear wall. A channel is positioned in the rear wall between an outer surface of the rear wall and an inner surface of the rear wall. The channel has an upper end that is in communication with the elongated guides. A cover is mounted on the elongated guide and is positionable in a closed position closing the opening or in an open position exposing the opening. The cover is removably positioned in the channel when the cover is in the open position. A pair of wheels is rotatably coupled to the housing at a juncture of the perimeter wall and the bottom wall. The wheels extend downwardly from the bottom wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a garbage receptacle assembly according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is a cross-sectional view of an embodiment of the disclosure taken along line 5-5 of FIG. 3.

### DESCRIPTION OF THE PREFERRED EMBODIMENT

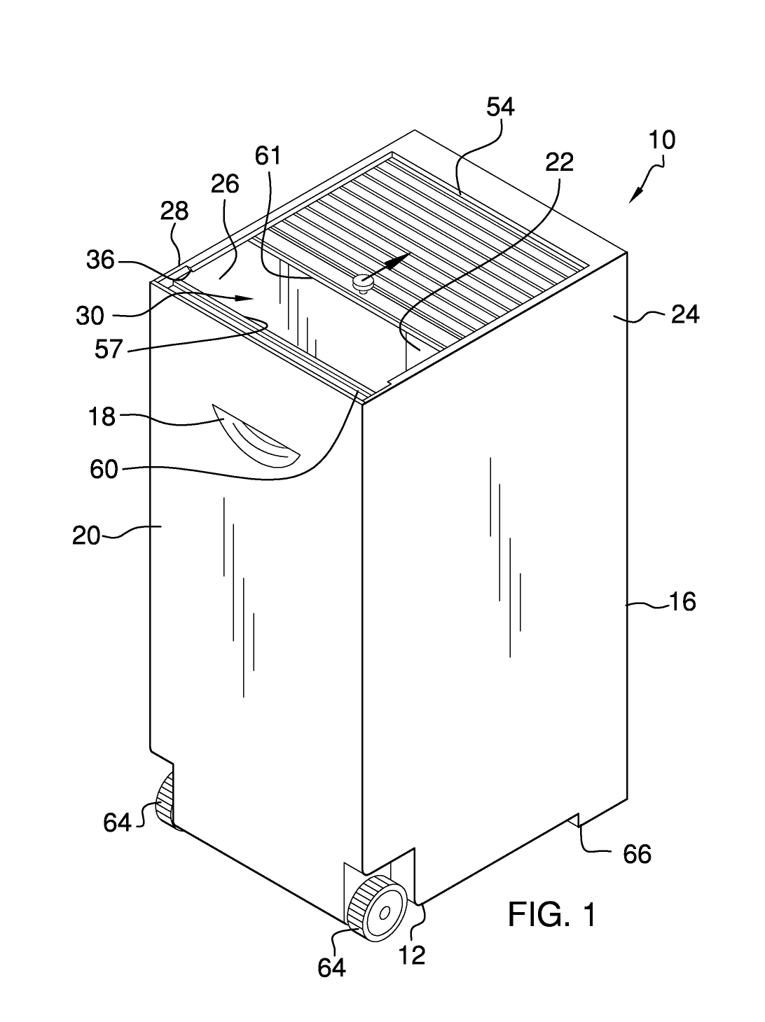

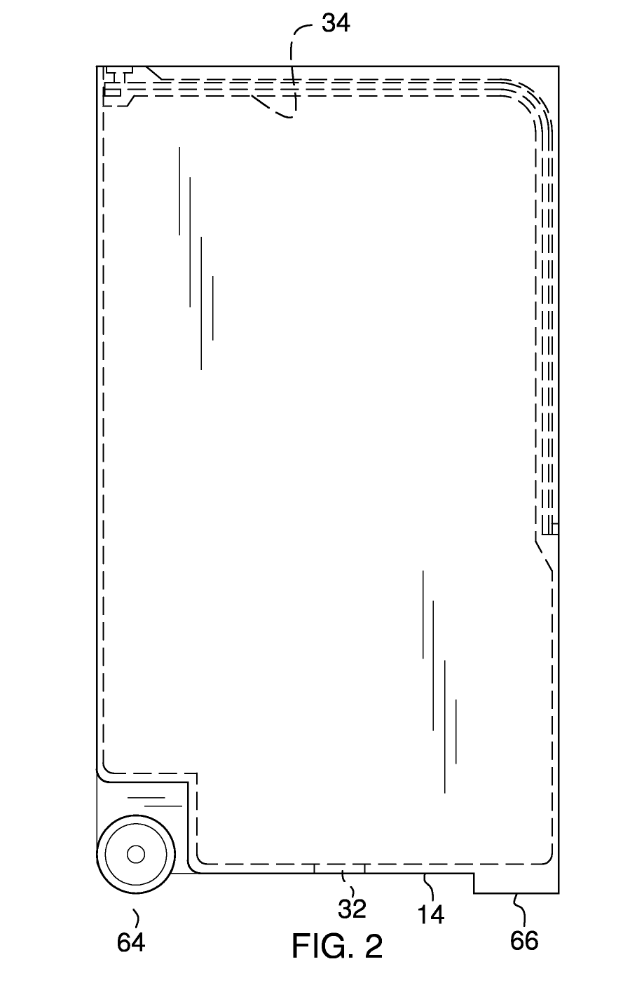

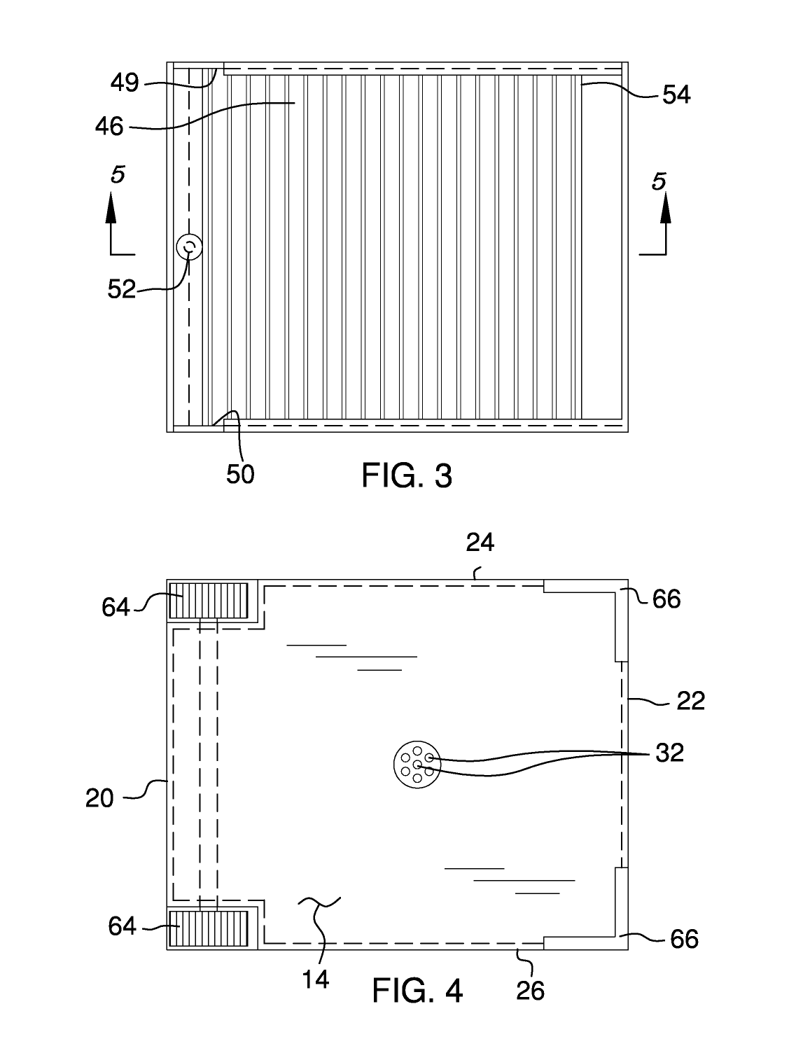

With reference now to the drawings, and in particular to FIGS. 1 through 5 thereof, a new garbage can device embodying the principles and concepts of an embodiment of the disclosure and generally designated by the reference numeral 10 will be described.

As best illustrated in FIGS. 1 through 5, the garbage receptacle assembly 10 generally comprises a housing 12 that has a bottom wall 14 and a perimeter wall 16 that is attached to and extends upwardly from the bottom wall 14. The perimeter wall 16 includes a handle 18 and may include multiple handles. The handle 18 may be attached to the perimeter wall or formed in the perimeter 16. The perimeter wall 16 includes a front wall 20, a rear wall 22, a first lateral wall 24 and a second lateral wall 26. The perimeter wall 16 has an upper edge 28 defining an opening 30 extending into the housing 12. The perimeter wall 16 has a height greater than 3.0 feet and the housing 12 has a length and width each being greater than 2.0 feet. The bottom wall 14 has a drainage hole 32 extending therethrough.

A pair of elongated guides 34, 36 is positioned in the housing 12 adjacent to the upper edge 28. Each of the first 24 and second 26 lateral walls has one of the elongated guides 34, 36 extending from the front wall 20 to the rear wall 22. A channel 38 is positioned in the rear wall 22 between an outer surface 40 of the rear wall 22 and an inner surface 42 of the rear wall 22. The channel 38 has an upper end that is in communication with the elongated guides 34, 36. The outer surface 40 has an aperture 44 therein extending into the channel 38 adjacent a bottom end of the channel 38.

A cover 46 is mounted on the elongated guides 34, 36. The cover 46 is positionable in a closed position closing the opening 30 or in an open position exposing the opening 30. The cover 46 is removably positioned in the channel 38 when the cover 46 is in the open position. The cover 46 has a front edge 47, a rear edge 48, a first side edge 49 and a second side edge 50 wherein the front edge 47 abuts the front wall 20 when the cover 46 is in the closed position. The cover 46 is bendable along a line that is perpendicular to and extend through the front 47 and rear 48 edges. The cover 46 is rigid along lines extending through and is perpendicular to the first 49 and second 50 side edges. The cover 46 may be comprised of a plurality of elongated members extending between the first 49 and second 50 side edges and which are flexibly coupled together. A grip 52 is attached to the cover 46. The grip 52 extends upwardly from the cover 46. The grip 52 is positioned adjacent to the front edge 47. The upper edge 28 may have a lip 54 attached thereto and extending forward from the rear wall 22 to shield the channel 38 from the elements and against which the grip 52 will abut when the cover 46 is in a fully open position.

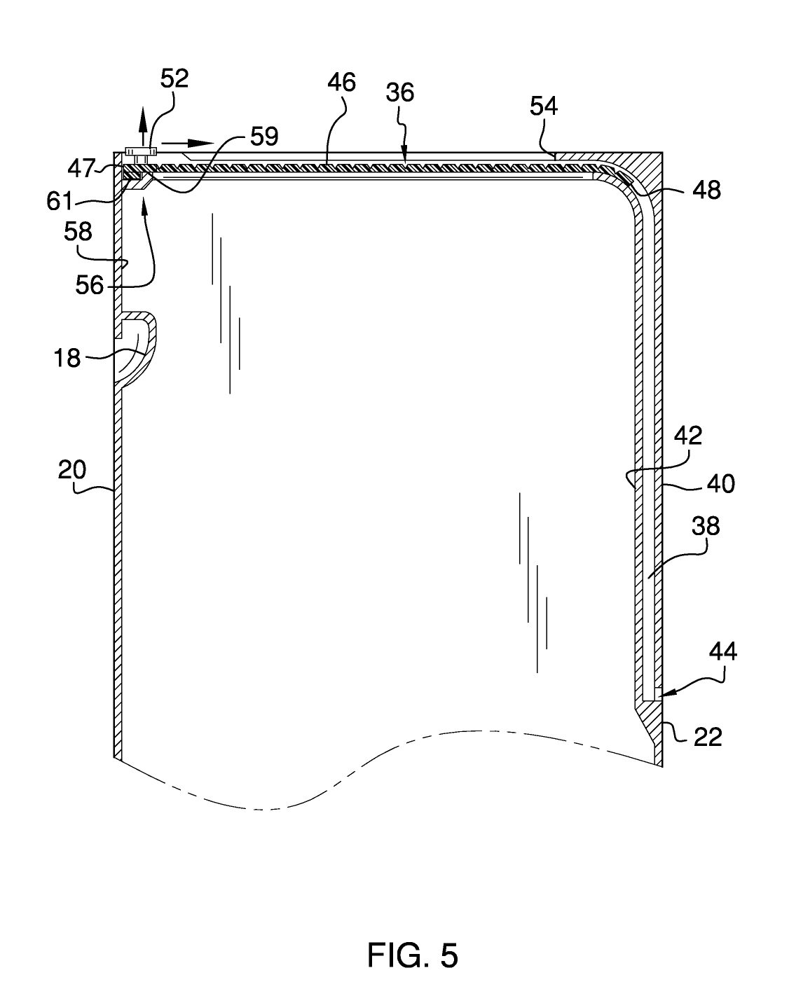

A securing member 56 is mounted on the perimeter wall 18 and releasably secures the cover 46 in the closed position. While many conventional securing members may be used, one may include a shoulder 57 that is attached to an interior surface 58 of the front wall 20. The shoulder 57 is elongated and extends between the first 24 and second 26 lateral walls. The shoulder 57 is spaced from the upper edge 28 a distance of less than 3.0 inches. The shoulder 57 has an upper surface 59 having a trough 60 therein. The cover 46 has a downwardly extending toe 61 attached thereto and positioned adjacent to the front edge 47. The toe 61 is removably positioned in the trough 60 to retain the cover 46 in the closed position as shown in FIG. 5.

A pair of wheels 64 is rotatably coupled to the housing 12 at a juncture of the perimeter wall 16 and the bottom wall 14 and the wheels 64 extend downwardly from the bottom wall 14. Each of the wheels 64 has a rotation of axis orientated perpendicular to a plane of the first lateral wall 24. Each of the first 24 and second 26 lateral walls has one of the wheels 64 positioned thereon and each of the wheels 64 is adjacent to the front wall 20. A pair of feet 66 is attached to the bottom wall 14 and extends downwardly therefrom. The feet 14 are positioned adjacent to the rear wall 22 and have a bottom edge that is co-planar with a lowermost extension of the wheels 64.

In use, the assembly 10 is used in a manner conventional to garbage cans. However, the assembly 10 includes a cover 46 which prevents accidental opening due to wind and cannot be easily opened by animals. Furthermore, the cover 46 remains in a low profile configuration even when in the open position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A garbage receptacle comprising:
a housing having a bottom wall and a perimeter wall being attached to and extending upwardly from said bottom wall, said perimeter wall including a front wall, a rear wall, a first lateral wall and a second lateral wall, said perimeter wall having an upper edge defining an opening extending into said housing, said perimeter wall having a height greater than 3.0 feet;
a handle, said handle being positioned on said front wall, said handle being formed into said front wall such that said handle is recessed into said front wall, said handle being downwardly spaced from said upper edge of said perimeter wall;
a pair of elongated guides being positioned in said housing adjacent to said upper edge, each of said first and second lateral walls having one of said elongated guides extending from said front wall to said rear wall;
a channel being positioned in said rear wall between an outer surface of said rear wall and an inner surface of said rear wall, said channel having an upper end being in communication with said elongated guides;
a cover being mounted on said elongated guides, said cover being positionable in a closed position closing said opening or in an open position exposing said opening, said cover being removably positioned in said channel when said cover is in said open position; and
a pair of wheels being rotatably coupled to said housing at a juncture of said perimeter wall and said bottom wall and extending downwardly from said bottom wall, each of said wheels being adjacent to said front wall.

2. The garbage receptacle according to claim 1, wherein said housing has a length and width each being greater than 2.0 feet.

3. The garbage receptacle according to claim 1, wherein said bottom wall has a drainage hole extending therethrough.

4. The garbage receptacle according to claim 1, wherein said outer surface has an aperture therein extending into said channel adjacent a bottom end of said channel.

5. The garbage receptacle according to claim 1, wherein said cover has a front edge, a rear edge, a first side edge and a second side edge wherein said front edge abuts said front wall when said cover is in said closed position, said cover being bendable along a line extending through and being perpendicular to said front and rear edges, said cover being rigid along lines extending through and being perpendicular to said first and second side edges.

6. The garbage receptacle according to claim 5, further including a grip being attached to said cover, said grip extending upwardly from said cover.

7. The garbage receptacle according to claim 6, wherein said grip is positioned adjacent to said front edge.

8. The garbage receptacle according to claim 5, further including a securing member being mounted on said perimeter wall and releasably securing said cover in said closed position.

9. The garbage receptacle according to claim 8, wherein said securing member includes a shoulder being attached to an interior surface of said front wall, said shoulder being elongated and extending between said first and second lateral walls, said shoulder being spaced from said upper edge a distance of less than 3.0 inches, said shoulder having an upper surface having a trough therein, said cover having a downwardly extending toe attached thereto and positioned adjacent to said front edge, said toe being removably positioned in said trough to retain said cover in said closed position.

10. The garbage receptacle according to claim 1, wherein each of said wheels has a rotation of axis orientated perpendicular to a plane of said first lateral wall, each of said first and second lateral walls having one of said wheels positioned thereon.

11. The garbage receptacle according to claim 10, further including a pair of feet being attached to said bottom wall and extending downwardly therefrom, said feet being positioned adjacent to said rear wall, said feet having a bottom edge being co-planar with a lowermost extension of said wheels.

12. A garbage receptacle comprising:
a housing having a bottom wall and a perimeter wall being attached to and extending upwardly from said bottom wall, said perimeter wall including a handle, said perimeter wall including a front wall, a rear wall, a first lateral wall and a second lateral wall, said perimeter wall having an upper edge defining an opening extending into said housing, said perimeter wall having a height greater than 3.0 feet, said housing having a length and width each being greater than 2.0 feet, said bottom wall having a drainage hole extending therethrough;
a handle, said handle being positioned on said front wall, said handle being formed into said front wall such that said handle is recessed into said front wall, said handle being downwardly spaced from said upper edge of said perimeter wall;
a pair of elongated guides being positioned in said housing adjacent to said upper edge, each of said first and second lateral walls having one of said elongated guides extending from said front wall to said rear wall;
a channel being positioned in said rear wall between an outer surface of said rear wall and an inner surface of said rear wall, said channel having an upper end being in communication with said elongated guides, said outer surface having an aperture therein extending into said channel adjacent a bottom end of said channel;
a cover being mounted on said elongated guides, said cover being positionable in a closed position closing said opening or in an open position exposing said opening, said cover being removably positioned in said channel when said cover is in said open position, said cover having a front edge, a rear edge, a first side edge and a second side edge wherein said front edge abuts said front wall when said cover is in said closed position, said cover being bendable along a line extending through and being perpendicular to said front and rear edges, said cover being rigid along lines extending through and being perpendicular to said first and second side edges;
a grip being attached to said cover, said grip extending upwardly from said cover, said grip being positioned adjacent to said front edge;
a securing member being mounted on said perimeter wall and releasably securing said cover in said closed position, said securing member including a shoulder being attached to an interior surface of said front wall, said shoulder being elongated and extending between said first and second lateral walls, said shoulder being spaced from said upper edge a distance of less than 3.0 inches, said shoulder having an upper surface having a trough therein, said cover having a downwardly extending toe attached thereto and positioned adjacent to said front edge, said toe being removably positioned in said trough to retain said cover in said closed position;
a pair of wheels being rotatably coupled to said housing at a juncture of said perimeter wall and said bottom wall and extending downwardly from said bottom wall, each of said wheels having a rotation of axis orientated perpendicular to a plane of said first lateral wall, each of said first and second lateral walls having one of said wheels positioned thereon, each of said wheels being adjacent to said front wall; and
a pair of feet being attached to said bottom wall and extending downwardly therefrom, said feet being positioned adjacent to said rear wall, said feet having a bottom edge being co-planar with a lowermost extension of said wheels.
